(19) United States
(12) Patent Application Publication
(10) Pub. No.: US 2017/0063622 A1
(43) Pub. Date: Mar. 2, 2017

(54) INFORMATION PROCESSING APPARATUS, COMPUTER-READABLE RECORDING MEDIUM, AND INFORMATION PROCESSING SYSTEM

(71) Applicant: FUJITSU LIMITED, Kawasaki-shi (JP)

(72) Inventors: Akimasa Yoshida, Nagoya (JP); Tomoyuki Kumeta, Shiroi (JP); Keita Murakami, Kawasaki (JP); YASUHIRO KAWASAKI, KOBE (JP)

(73) Assignee: FUJITSU LIMITED, Kawasaki-shi (JP)

(21) Appl. No.: 15/187,375

(22) Filed: Jun. 20, 2016

(30) Foreign Application Priority Data
Aug. 25, 2015 (JP) 2015-166163

(51) Int. Cl. H04L 12/24; H04L 12/26

(52) U.S. Cl. CPC H04L 41/0836; H04L 43/08; H04L 43/04; H04L 41/046; H04L 41/0816; H04L 41/142; H04L 43/16

(57) ABSTRACT

An information processing apparatus includes a memory and a processor. The processor is coupled to the memory. The processor acquires information on the safety of locations where multiple data centers are placed through a network. The multiple data centers are able to communicate with one another. The processor calculates scores respectively indicating the safety of the multiple data centers on the basis of the acquired information. The processor further determines whether to move virtual machines built on each of the multiple data centers on the basis of the scores. The processor moves virtual machines placed in one data center to another data center on the basis of a result of the determination.

### CROSS-REFERENCE TO RELATED APPLICATION(S)

This application is based upon and claims the benefit of priority of the prior Japanese Patent Application No. 2015-166163, filed on Aug. 25, 2015, the entire contents of which are incorporated herein by reference.

### FIELD

The embodiments discussed herein are related to an information processing apparatus, a computer-readable recording medium, and an information processing system.

### BACKGROUND

Recently, with the spread of cloud computing, it is becoming common for users such as companies to use resources such as servers and storage provided as cloud services. Furthermore, data centers where resources of cloud computing are located may be placed across multiple countries.

When a cloud service is to be provided through any of the data centers placed across multiple countries, it is preferable to control the quality of the cloud service so as not to be affected by geographical and physical conditions of the country where the data center is placed. Accordingly, there has been a demand for a cloud-service operations management technology that can provide a service with prescribed quality regardless of location where a data center is placed.

There is a technology that, for example, when one of multiple data centers, which are connected to one another so that they can transmit and receive data among them, has broken down, moves its system to another data center using a migration function.

With regard to the conventional technology, see, for example, Japanese Laid-open Patent Publication No. 2011-209811, Japanese Laid-open Patent Publication No. 2010-237926, and Japanese Laid-open Patent Publication No. 2003-30770.

However, in conventional technologies, risk factors other than breakdowns etc. that occur in resources of data centers are not fully taken into account.

### SUMMARY

According to an aspect of an embodiment, an information processing apparatus includes a memory and a processor. The processor is coupled to the memory and executes a process. The process includes acquiring information on safety of locations where multiple data centers are placed through a network, the multiple data centers being able to communicate with one another. The process further includes calculating scores respectively indicating the safety of the multiple data centers on the basis of the acquired information. The process further includes firstly determining whether to move virtual machines built on each of the multiple data centers on the basis of the scores. The process further includes moving virtual machines placed in one data center to another data center on the basis of a result of the determination in the firstly determining.

According to another aspect of an embodiment, a non-transitory computer-readable recording medium has stored therein a migration control program that causes a computer to execute a process. The process includes acquiring information on safety of locations where multiple data centers are placed through a network, the multiple data centers being able to communicate with one another. The process further includes calculating scores respectively indicating the safety of the multiple data centers on the basis of the acquired information. The process further includes determining whether to move virtual machines built on each of the multiple data centers on the basis of the calculated scores. The process further includes moving virtual machines placed in one data center to another data center on the basis of a result of the determination.

According to still another aspect of an embodiment, an information processing system includes multiple data centers and an information processing apparatus. The multiple data centers are placed in different locations, respectively, and are able to communicate with one another. The information processing apparatus includes a memory and a processor coupled to the memory and executes a process. The process includes acquiring information on safety of the locations where the multiple data centers are placed, respectively, through a network. The process further includes calculating scores respectively indicating the safety of the multiple data centers on the basis of the acquired information. The process further includes a firstly determining whether to move virtual machines built on each of the multiple data centers on the basis of the scores. The process further includes moving virtual machines placed in one data center to another data center on the basis of a result of the determination in the firstly determining.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a hardware configuration of an information processing system according to a first embodiment;

FIG. 2 is a diagram illustrating a functional configuration of a data center according to the first embodiment;

FIG. 3 is a diagram illustrating an example of a configuration of an information processing apparatus according to the first embodiment;

FIG. 4 is a diagram illustrating an example of data components of attendance/leaving information according to the first embodiment;

FIG. 5 is a diagram illustrating an example of data components of data-center management information according to the first embodiment;

FIG. 6 is a diagram illustrating an example of data components of event management information according to the first embodiment;

FIG. 7 is a diagram illustrating an example of data components of user management information according to the first embodiment;

FIG. 8 is a flowchart illustrating an example of the procedure of a migration control process according to the first embodiment;

FIG. 9 is a flowchart illustrating an example of the procedure of an external-risk-factor detecting process;

FIG. 10 is a flowchart illustrating an example of the procedure of an internal-risk-factor detecting process;

FIG. 11 is a flowchart illustrating an example of the procedure of a first migration process;

FIG. 12 is a flowchart illustrating an example of the procedure of a second migration process;

FIG. 13 is a diagram illustrating an example of a configuration of an information processing apparatus according to a second embodiment;

FIG. 14 is a diagram illustrating an example of data components of data-center management information according to the second embodiment;

FIG. 15 is a diagram illustrating an example of data components of user management information according to the second embodiment;

FIG. 16 is a flowchart illustrating an example of the procedure of a migration control process according to the second embodiment;

FIG. 17 is a flowchart illustrating an example of the procedure of a migration process according to the second embodiment;

FIG. 18 is a diagram illustrating an example of a system configuration that realizes an information processing system according to any of the embodiments;

FIGS. 19A and 19B are sequence charts illustrating an example of the procedure of a migration control process in the information processing system according to any of the embodiments; and

FIG. 20 is a diagram illustrating a computer that executes a migration control program.

### DESCRIPTION OF EMBODIMENTS

Preferred embodiments of the present invention will be explained with reference to accompanying drawings. In the present embodiments, there is described an example of an information processing system including multiple data centers that provide a virtual machine. Incidentally, this invention is not limited by the present embodiments. The embodiments can be combined accordingly within a range that causes no contradiction in the processing content.

### [a] First Embodiment

Configuration of Information Processing System According to First Embodiment

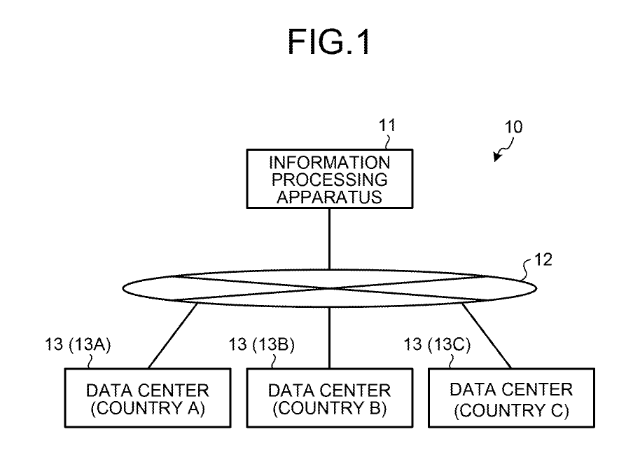

FIG. 1 is a diagram illustrating a hardware configuration of an information processing system 10 according to a first embodiment. As illustrated in FIG. 1, the information processing system 10 includes an information processing apparatus 11. The information processing apparatus 11 is connected to multiple data centers (DCs) 13 via a network 12. The multiple data centers 13 are each connected to the network 12. The network 12 can be either a leased line or not a leased line. In the information processing system 10, the information processing apparatus 11 acquires respective pieces of information of the data centers 13 via the network 12. Then, in the information processing system 10, it shall be possible to perform migration of a virtual machine (VM) among the data centers 13 via the network 12. Incidentally, in an example illustrated in FIG. 1, three data centers 13 (13A, 13B, and 13C) are depicted; however, the number of the data centers 13 can be any number as long as it is two or more.

The data centers 13 are placed in locations geographically distant from one another. In the present embodiment, the data centers 13 shall be placed in different areas, such as different countries. For example, the data centers 13A, 13B, and 13C shall be located in Country A, Country B, and Country C, respectively.

Hardware Configuration of Data Center

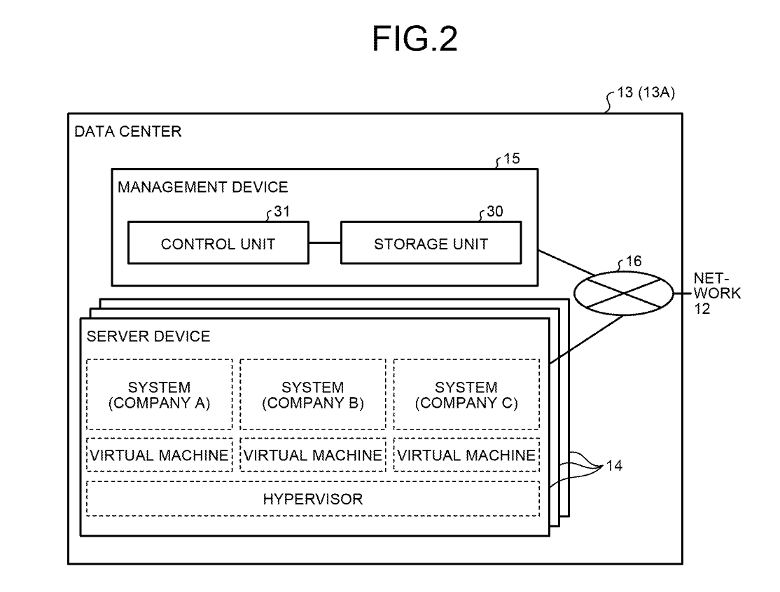

Subsequently, a functional configuration of a data center 13 is explained with reference to FIG. 2. FIG. 2 is a diagram illustrating a functional configuration of a data center 13 according to the first embodiment. Incidentally, the data centers 13A, 13B, and 13C have about the same functional configuration; therefore, an example of the functional configuration is explained below as the configuration of the data centers 13.

The data center 13 includes multiple server devices 14 and a management device 15. Each of the server devices 14 and the management device 15 are connected by a network 16, and can communicate with each other. This network 16 is connected to the network 12 so as to allow for communication, and therefore the data center 13 can communicate with the other data centers 13 via the network 12. Incidentally, in the example illustrated in FIG. 2, three server devices 14 are depicted; however, the data center 13 can include any number of server devices 14. Furthermore, in the example illustrated in FIG. 2, one management device 15 is depicted; however, two or more management devices 15 can be included.

The server devices 14 are physical servers that each provide various services to users by operating a virtual machine that is a virtualized computer, and are, for example, server computers. The server devices 14 each execute a server virtualization program thereby operating a plurality of virtual machines on a hypervisor and causing client-appropriate application programs to run on the virtual machines to get clients' systems to work.

The management device 15 is a physical server that performs the management and operations of the server devices 14, and is, for example, a server computer. The management device 15 manages the virtual machines running on each server device 14.

The management device 15 includes a storage unit 30 and a control unit 31. The storage unit 30 stores therein information on each server device 14 placed in the data center 13 and information on users of virtual machines built on the server device 14. Furthermore, the storage unit 30 stores therein the attendance state of employees who work at the data center 13. The control unit 31 acquires information on the employee attendance state. For example, the management device 15 can be configured to be connected to information processing terminals placed in the data center 13, and the control unit 31 can be configured to collect attendance/leaving information that each employee inputs to his/her information processing terminal and store the collected attendance/leaving information in the storage unit 30. Furthermore, the control unit 31 controls and executes migration of the virtual machines to be built on a server device 14. Incidentally, the configuration of the management device 15 is not specifically limited; alternatively, one management device 15 can be shared by multiple data centers.

Example of Configuration of Information Processing Apparatus According To First Embodiment

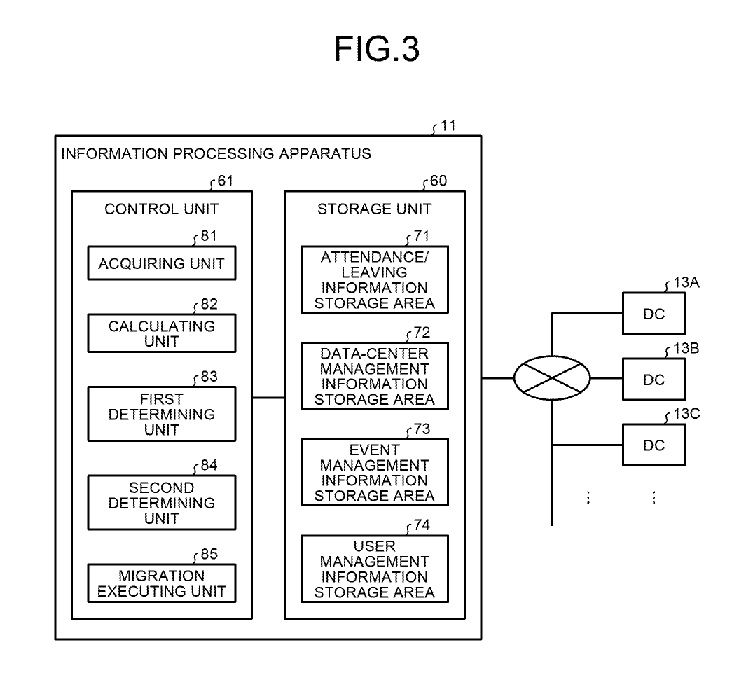

FIG. 3 is a diagram illustrating an example of a configuration of the information processing apparatus 11 according to the first embodiment. The information processing apparatus 11 acquires information related to risks in each data center 13 from the data center 13, and moves resources of a high-risk data center 13 to a low-risk data center 13. The risks here mean the overall factors that affect the provision of services by a data center 13. For example, the risks shall include the following two: internal risks detected on the basis of information inside the data center 13 and external risks detected on the basis of information outside the data center 13. The internal risks are, for example, risks detected on the basis of the employee attendance state of the data center 13. The external risks are, for example, risks detected on the basis of overseas travel safety information etc. that a public institution of the country in which the data center 13 is placed delivers via the Internet etc. The information processing apparatus 11 in the first embodiment detects both internal risks and external risks, and determines whether to perform migration or not, and performs migration based on the determination.

The information processing apparatus 11 according to the first embodiment illustrated in FIG. 3 includes a storage unit 60 and a control unit 61. Incidentally, the information processing apparatus 11 can include various function units that a known computer has besides the function units illustrated in FIG. 3. For example, the information processing apparatus 11 can further include a display unit that displays thereon a variety of information and an input unit that inputs a variety of information.

The storage unit 60 is a storage device that stores therein various data. For example, the storage unit 60 is a storage device such as a hard disk, a solid state drive (SSD), or an optical disk. Incidentally, the storage unit 60 can be a data-rewritable semiconductor memory, such as a random access memory (RAM), a flash memory, or a non-volatile static random access memory (NVSRAM).

The storage unit 60 stores therein an operating system (OS) and various programs executed by the control unit 61. For example, the storage unit 60 stores therein various programs including programs that perform an external-risk-factor detecting process, an internal-risk-factor detecting process, a first migration process, and a second migration process to be described later. Furthermore, the storage unit 60 stores therein various data used in the programs executed by the control unit 61. For example, the storage unit 60 has an attendance/leaving information storage area 71, a data-center management information storage area 72, an event management information storage area 73, and a user management information storage area 74.

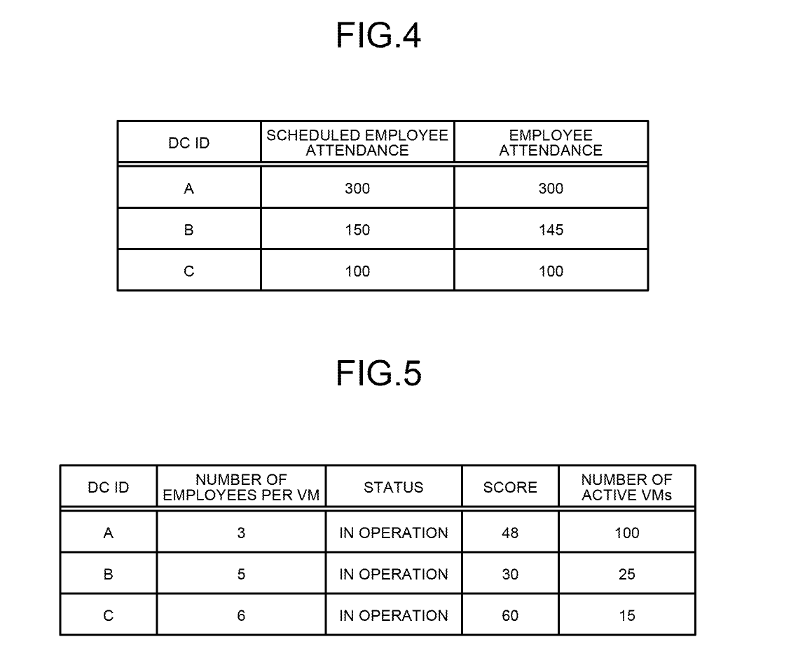

The attendance/leaving information storage area 71 stores therein attendance/leaving information that is information on the employee attendance state in each data center 13. FIG. 4 is a diagram illustrating an example of data components of attendance/leaving information according to the first embodiment. As illustrated in FIG. 4, the attendance/leaving information includes “DC ID”, “scheduled employee attendance”, and “employee attendance”. The “DC ID” is an identifier that uniquely identifies a data center 13 that is connected to the information processing apparatus 11 via the network 12 and is subjected to migration management by the information processing apparatus 11. The “scheduled employee attendance” is the number of employees scheduled to work at the data center 13. The “employee attendance” is the number of employees being actually at work out of the scheduled employee attendance. For example, it is assumed that in each data center 13, employees' attendance and leaving are managed in such a manner that each employee inputs the clock-in and -out times to his/her timecard on an information processing terminal. In this case, the information processing apparatus 11 acquires information input to timecards by employees in each data center 13, and stores the acquired information in the storage unit 60. In the example illustrated in FIG. 4, information in which “DC ID: A” is associated with “scheduled employee attendance: 300” and “employee attendance: 300” is stored. This indicates that in a data center identified by DC ID “A”, 300 employees are scheduled to work, and the actual attendance was all the 300 employees.

The data-center management information storage area 72 stores therein data-center management information that is information on virtual machines currently running on each data center 13 managed by the information processing apparatus 11. FIG. 5 is a diagram illustrating an example of data components of data-center management information according to the first embodiment. As illustrated in FIG. 5, the data-center management information includes “DC ID”, “number of employees per VM”, “status”, “score”, and “number of active VMs”. The “DC ID” is the same as that illustrated in FIG. 4. The “number of employees per VM” indicates the number of employees allocated for one virtual machine in a data center identified by the DC ID. That is, the “number of employees per VM” is the number of employees for the operations management of one virtual machine. The “number of employees per VM” differs among data centers according to respective skill levels of employees in each data center, etc. The “status” indicates the operating status of the data center. For example, if “status” indicates “in operation”, which means that the data center is currently in operation. Furthermore, if “status” indicates “not in operation”, which means that the data center is currently not in operation. The “score” indicates an evaluation value of external risks in each data center. In other words, the score is an evaluation value of the safety of each data center that is calculated on the basis of information relating to the safety of the country or area where the data center is placed. A method for calculating a score will be described later in association with event management information. The “number of active VMs” indicates the number of virtual machines that have been built on the data center. For example, in the example illustrated in FIG. 5, information in which “DC ID: A” is associated with “number of employees per VM: 3”, “status: in operation”, “score: 48”, and “number of active VMs: 100” is stored. This indicates that in a data center identified by DC ID “A”, three employees are allocated for each virtual machine. Furthermore, this indicates that the data center is currently in operation, and the number of active VMs is 100. Moreover, this indicates that a score of the data center, which is an evaluation value of the safety of the data center, is “48”.

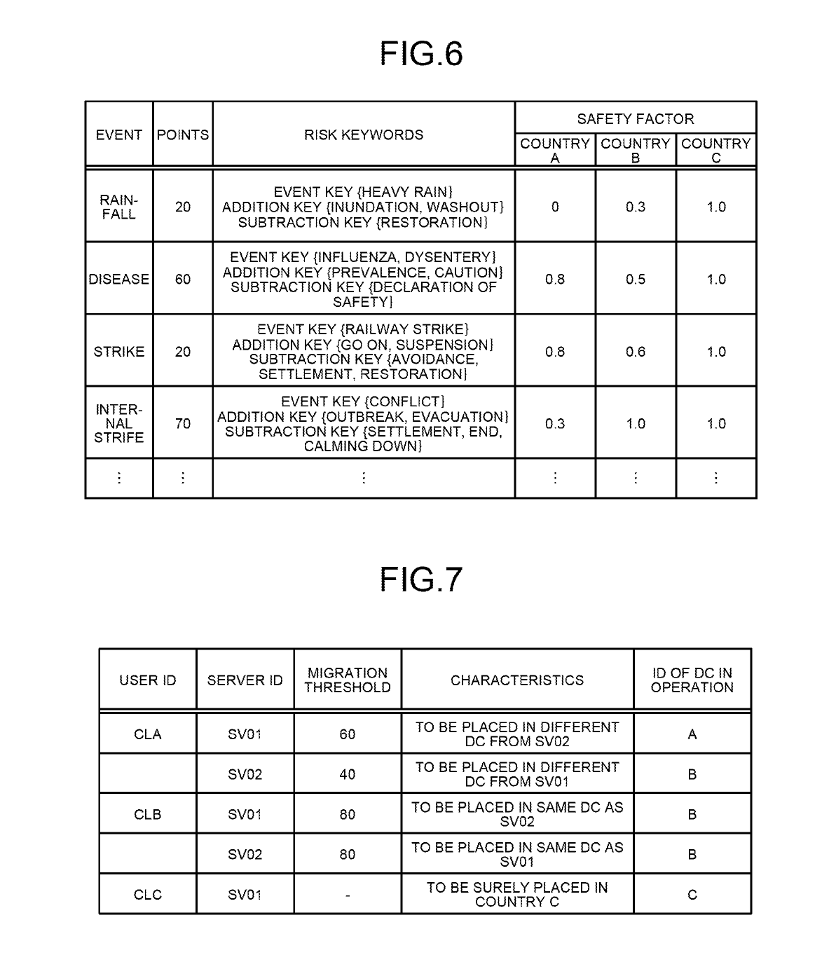

The event management information storage area 73 stores therein event management information that is information for evaluating a matter which constitutes an external risk factor. FIG. 6 is a diagram illustrating an example of data components of event management information according to the first embodiment. As illustrated in FIG. 6, the event management information includes “event”, “points”, “risk keywords”, and “safety factor”.

The “event” is an event that may affect the safety the country or area where a data center is placed. That is, the “event” is an event that constitutes an external risk factor. For example, rainfall that is a natural disaster, disease, a strike, and internal strife that are an index of the unstable conditions of a country, etc. are cited as an “event”.

The “points” is a numerical value of the degree of how largely the safety is affected by an event. That is, the “points” is a numerical value of the degree of importance of an event as an external risk factor. Which means that the larger the numerical value of “points”, the higher the degree of how largely the event affects the safety; the smaller the numerical value of “points”, the lower the degree of how largely the event affects the safety.

The “risk keywords” are search words used to detect the occurrence of an event and the end of the event by searching information acquired by the information processing apparatus 11 by the words. The “risk keywords” include an “event key”, an “addition key”, and a “subtraction key”. The “event key” is a word directly indicating an event that constitutes an external risk factor. For example, when a natural disaster caused by rainfall is to be extracted as an external risk factor, “heavy rain” can be set as an event key. The “addition key” is a word representing a matter that triggers a threat to the safety affected by the event. For example, a word implicating the occurrence of damage caused by rainfall can be set as an addition key corresponding to the event key “heavy rain”. For example, “inundation” and “washout” can be set as addition keys corresponding to the event key “heavy rain”. The “subtraction key” is a word meaning that the event has come to an end and no longer affects the safety. For example, “restoration” can be set as a subtraction key corresponding to the event key “heavy rain”.

The “safety factor” is an evaluation value of the degree of an event impact in each location where a data center is placed. For example, in a country where there is little rainfall throughout the year, the event “rainfall” is thought to hardly affect the safety. On the other hand, in a country where the rainy season lasts for half a year and is behind in measures against flood-control works etc. thereby suffers flood or inundation damage every year, the event “rainfall” largely affects the safety. Accordingly, the magnitude of impact of the event “rainfall” is converted into a numerical value and set as a “safety factor” with respect to each country. For example, a safety factor corresponding to the event “rainfall” in “Country A” with little rainfall is set to “0”, and a safety factor corresponding to the event “rainfall” in “Country C” with a long rainy season is set to “1.0”.

The information processing apparatus 11 according to the first embodiment calculates a “score” of each data center on the basis of information acquired from the Internet etc., data-center management information, and event management information. For example, the information processing apparatus 11 acquires information about each country where a data center is placed from the Internet through a mailing list and the function of an RSS reader. Then, the information processing apparatus 11 searches the acquired information for an “event key” and an “addition key” as search keywords. When any hit has been detected through the AND search for the “event key” and the “addition key”, the information processing apparatus 11 adds a value obtained by multiplying points of an event by a safety factor of the country to a score of a data center of the country. Furthermore, the information processing apparatus 11 searches the acquired information for the “event key” and a “subtraction key” as search keywords. When any hit has been detected through the AND search for the “event key” and the “subtraction key”, the information processing apparatus 11 subtracts the value obtained by multiplying the points of the event by the safety factor of the country from the score of the data center of the country. When the information processing apparatus 11 has acquired new information, the information processing apparatus 11 identifies a country related to the information, and performs a search based on risk keywords of each event, and then calculates a score and updates the score with the calculated score.

Here we explain taking an example of calculating a score of a data center placed in Country A. It is assumed that a strike occurred due to political instability in Country A, and information on the strike published in a newsletter sent by the foreign ministry of Country A. The information processing apparatus 11 acquires data of the newsletter sent by the foreign ministry of Country A, and performs a search on the acquired data with respective risk keywords corresponding to events. First, the information processing apparatus 11 selects one “event” that has been stored in the event management information storage area 73 in advance, and performs an AND search with an “event key” and an “addition key” that correspond to the event. Furthermore, the information processing apparatus 11 performs an AND search with the “event key” and a “subtraction key”. Here, it is assumed that there are no hits by respective combinations of “event key” and “addition key” corresponding to the events “rainfall”, “disease”, and “internal strife”, though it has been detected that a combination of “event key” and “addition key” corresponding to an event “strike” made a hit. Furthermore, it is assumed that as for combinations of “event key” and “subtraction key”, no hits detected for any of the events. In this case, a numerical value obtained by multiplying “20”, points corresponding to the event “strike”, by “0.8”, a safety factor of Country A, is added to a “score” of a data center placed in Country A. In this example, “16” is added to a score of a data center with “DC ID: A” in Country A.

It is assumed that as a result of the calculation described above, a score of the data center with “DC ID: A” stored in the data-center management information storage area 72 has become “64”. And, it is assumed that after that, the strike in Country A has come to an end. Then, it is assumed that the information processing apparatus 11 has received a newsletter again and performed a search with risk keywords. At this time, it is assumed that there are hits in a search by a combination of “event key” and “subtraction key” corresponding to event “disease” and also in a search by a combination of “event key” and “subtraction key” corresponding to the event “strike”. In this case, a value obtained by multiplying “60”, points corresponding to the event “disease”, by “0.8”, the safety factor of Country A, and a value obtained by multiplying “20”, points corresponding to the event “strike”, by “0.8”, the safety factor of Country A, are calculated. Then, the calculated values are subtracted from the “score” of the data center placed in Country A. In this example, “48+16” is subtracted from the score “64”, and the score becomes “0”.

In this way, when the information processing apparatus 11 has detected the occurrence of a matter that affects the safety of a location where a data center is placed, the information processing apparatus 11 calculates a value indicating the degree of risk as a value of multiplication of “points” by “safety factor” and adds the calculated value to the score. Furthermore, when the information processing apparatus 11 has detected the end or disappearance of a matter that affects the safety of a location where a data center is placed, the information processing apparatus 11 calculates a value indicating the degree of risk as a value of multiplication of “points” by “safety factor” and subtracts the calculated value from the score.

The user management information storage area 74 stores therein user management information that is information on a user who has been receiving the provision of a resource of a data center 13 managed by the information processing apparatus 11 and the content of a service to the user. FIG. 7 is a diagram illustrating an example of data components of user management information according to the first embodiment. In FIG. 7, “server ID”, “migration threshold”, “characteristics”, and “ID of DC in operation” are stored to be associated with “user ID”.

The “user ID” is an identifier that uniquely identifies a user who receives the provision of a resource of a data center 13. The “server ID” is an identifier that uniquely identifies one of servers placed in the data center 13. The “migration threshold” is an evaluation value of the safety of a server that each user uses. The information processing apparatus 11 migrates a server associated with a migration threshold if a score of a data center where the server is placed exceeds the migration threshold.

In the example illustrated in FIG. 7, for example, a migration threshold of “60” is stored to be associated with user ID “CLA” and server ID “SV01”. This means a server with server ID “SV01” allocated for a user with user ID “CLA” demands a score of 60 or less of a data center where the server is placed. That is, if the score of the data center where the server with server ID “SV01” is placed exceeds 60, the information processing apparatus 11 migrates the server to another data center.

The “characteristics” indicates conditions etc. to fulfill when a resource allocated for the user is placed/moved. For example, “characteristics: To be placed in a different DC from SV02” is stored to be associated with “server ID: SV01”. This means the server identified by server ID “SV01” has to be placed in a different data center from a data center where a server with server ID “SV02” is placed. Furthermore, “characteristics: To be surely placed in Country C” is stored to be associated with “server ID: SV01”. This means the server identified by server ID “SV01” has to be surely placed in a data center in Country C.

In the example illustrated in FIG. 7, for example, “server ID: SV01”, “migration threshold: 60”, “characteristics: To be placed in a different DC from SV02”, and “ID of DC in operation: A” are stored to be associated with “user ID: CLA”. This means a user identified by user ID “CLA” is using the server identified by server ID “SV01”. Furthermore, a service using the server demands the slightly lower degree of safety indicated by the migration threshold of “60”. Then, the server “SV01” that the user is using has to be placed in a different data center from the server “SV02”. Moreover, the data center where the server “SV01” is placed at this point of time is a data center identified by DC ID “A”.

To return to FIG. 3, the control unit 61 is a device that controls the information processing apparatus 11. As the control unit 61, electronic circuits, such as a central processing unit (CPU) and a micro processing unit (MPU), or integrated circuits, such as an application specific integrated circuit (ASIC) and a field programmable gate array (FPGA), can be adopted. The control unit 61 has an internal memory for storing therein various programs and control data that define processing procedures, and executes various processes with these. The control unit 61 serves as various processing units by the activation of the programs. For example, the control unit 61 includes an acquiring unit 81, a calculating unit 82, a first determining unit 83, a second determining unit 84, and a migration executing unit 85.

The acquiring unit 81 acquires various data. For example, the acquiring unit 81 according to the first embodiment acquires information associated with the safety in an area or country where each data center is placed. Therefore, the information processing apparatus 11, for example, registers itself in a mailing list to which information on the safety in an area or country where each data center is placed is delivered in advance. Furthermore, for example, a feed reader such as an RSS reader that cruises around websites and receives updates is set in the information processing apparatus 11. However, the method to acquire the safety information is not specifically limited to these, and any other method can be used as long as the information processing apparatus 11 can acquire information associated with the safety in an area or country where each data center is placed.

The acquiring unit 81 also acquires information on the employee attendance/leaving state from each data center 13, and stores the acquired information in the attendance/leaving information storage area 71 of the storage unit 60 and updates the attendance/leaving information storage area 71 of the storage unit 60.

The calculating unit 82 calculates and updates the score associated with each data center stored in the data-center management information storage area 72.

The calculating unit 82 calculates and updates the score at the predetermined timing. For example, at the timing at which new information has been acquired by the acquiring unit 81, the calculating unit 82 calculates and updates the score. Furthermore, the calculating unit 82 can be configured to calculate and update the score at predetermined time intervals. Data centers subject to the score calculation and update can be limited to only ones placed in an area or country associated with the newly acquired information.

The first determining unit 83 compares a score stored in the data-center management information storage area 72 with a migration threshold stored in the user management information storage area 74, and identifies a combination of a user and a server of which the data center's score exceeds the migration threshold. The first determining unit 83 determines that an external risk to the server of which the data center's score exceeds the migration threshold has exceeded a predetermined level. That is, the first determining unit 83 determines that the server has an external risk factor. Then, the first determining unit 83 determines that the server of which the data center's score exceeds the migration threshold is subject of a migration process. On the other hand, as for a server of which the data center's score is equal to or less than the migration threshold, the first determining unit 83 determines that an external risk to the server has not exceeded the predetermined level. That is, the first determining unit 83 determines that the server has no external risk factor. Then, the first determining unit 83 determines that the server of which the data center's score is equal to or less than the migration threshold is not subject of a migration process.

Incidentally, the determining process performed by the first determining unit 83 can be performed each time the calculating unit 82 has calculated and updated the score, or can be performed at predetermined time intervals.

The second determining unit 84 identifies a server of which the data center's score is greater than zero but not greater than the migration threshold with reference to the data-center management information storage area 72 and the user management information storage area 74. That is, the second determining unit 84 identifies a server that has an external risk but its external risk level has not exceeded a predetermined level. In other words, the second determining unit 84 identifies a server that has some sort of external risk but meets the safety level demanded by a user.

Then, as for a data center where the server of which the data center's score has been determined to be greater than zero but not greater than the migration threshold is placed, the second determining unit 84 determines whether the number of active VMs is the number that employees at work can cover. For example, the second determining unit 84 determines whether the number of employees at work is equal to or more than a value obtained by multiplying the “number of employees per VM” by the “number of active VMs” with reference to the attendance/leaving information storage area 71 and the data-center management information storage area 72. If the number of employees at work is equal to or more than the value obtained by multiplying the “number of employees per VM” by the “number of active VMs”, the second determining unit 84 determines that all the active VMs can be operated by the employees at work in the data center. That is, the second determining unit 84 determines that the data center has no internal risk factor. On the other hand, if the number of employees at work is less than the value obtained by multiplying the “number of employees per VM” by the “number of active VMs”, the second determining unit 84 determines that it is difficult for the employees at work to operate all the active VMs in the data center. That is, the second determining unit 84 determines that the data center has an internal risk factor.

In this way, the first and second determining units 83 and 84 determine whether a data center or a server has an external or internal risk factor. A server that has been determined to be at risk factor by the first determining unit 83 is not a subject of the process performed by the second determining unit 84. Therefore, it can be configured that information on a server that has been determined to be at risk factor by the first determining unit 83 is transmitted to the second determining unit 84 so that the server is removed from the subject of the process performed by the second determining unit 84.

The migration executing unit 85 performs a first migration process where a server that has been determined to have an external risk factor by the first determining unit 83 is a source of migration. Furthermore, the migration executing unit 85 performs a second migration process where a server placed in a data center that has been determined to have an internal risk factor by the second determining unit 84 is a source of migration. The details of the first and second migration processes will be described later.

Example of Flow of Migration Control Process

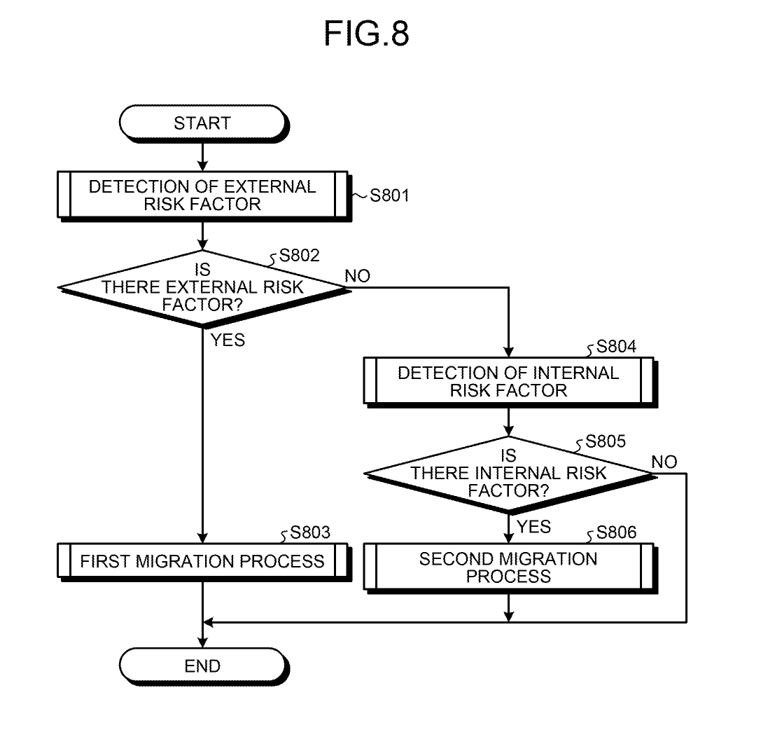

FIG. 8 is a flowchart illustrating an example of the procedure of a migration control process according to the first embodiment. The flow of the migration control process according to the first embodiment is explained with reference to FIG. 8.

In the migration control process according to the first embodiment, the information processing apparatus 11 determines whether each server has an external risk factor on the basis of a score of each data center that is an evaluation value of the safety of each data center (Step S801: Detection of an external risk factor). Then, if a server determined to have an external risk factor has been detected (YES at Step S802), the information processing apparatus 11 performs a first migration process (Step S803). On the other hand, if a server determined to have no external risk factor has been detected (NO at Step S802), the information processing apparatus 11 further determines whether the server has an internal risk factor (Step S804: Detection of an internal risk factor). Then, if the server determined to have an internal risk factor has been detected (YES at Step S805), the information processing apparatus 11 performs a second migration process (Step S806). On the other hand, if the server determined to have an internal risk factor has not been detected (NO at Step S805), the information processing apparatus 11 ends the process.

Example of Flow of External-Risk-Factor Detecting Process

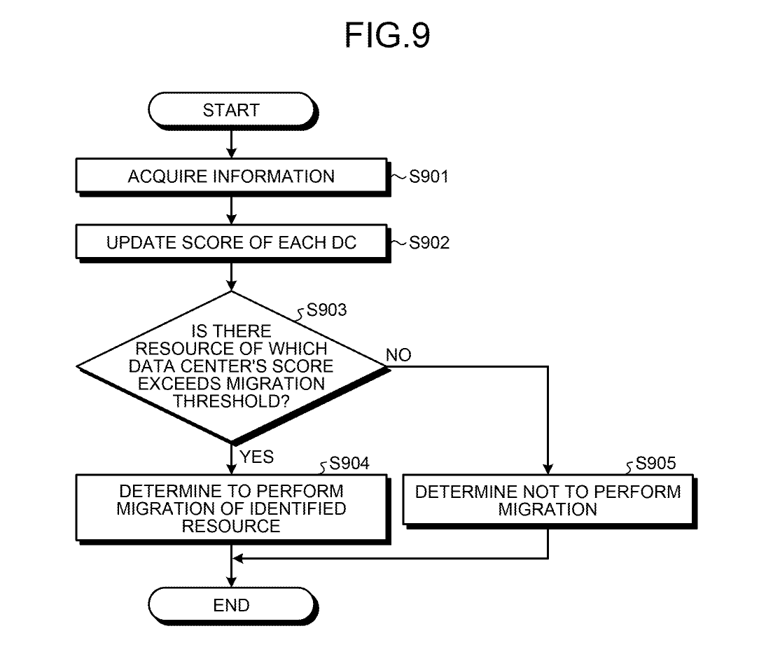

FIG. 9 is a flowchart illustrating an example of the procedure of an external-risk-factor detecting process. The processing flow illustrated in FIG. 9 corresponds to Step S801 in FIG. 8.

First, the acquiring unit 81 acquires information on the safety of an area or country where a data center is placed through a mailing list or an RSS reader (Step S901). Then, the calculating unit 82 identifies a country corresponding to the information acquired by the acquiring unit 81. Then, the calculating unit 82 performs a search with risk keywords on the acquired information, and calculates a score by using a safety factor corresponding to the identified country. The calculating unit 82 updates the score of the data center placed in the country which has been stored in the data-center management information storage area 72 with the calculated score (Step S902).

The first determining unit 83 determines whether there is any resource (server) of which the data center's score exceeds a migration threshold on the basis of the updated score (Step S903). If the first determining unit 83 has determined that there is a server of which the data center's score exceeds the migration threshold (YES at Step S903), the first determining unit 83 determines to perform a migration process on the server (Step S904). On the other hand, if the first determining unit 83 has determined that there is no server of which the data center's score exceeds the migration threshold (NO at Step S903), the first determining unit 83 determines not to perform a migration process (Step S905). Then, the external-risk-factor detecting process ends.

Example of Flow of Internal-Risk-Factor Detecting Process

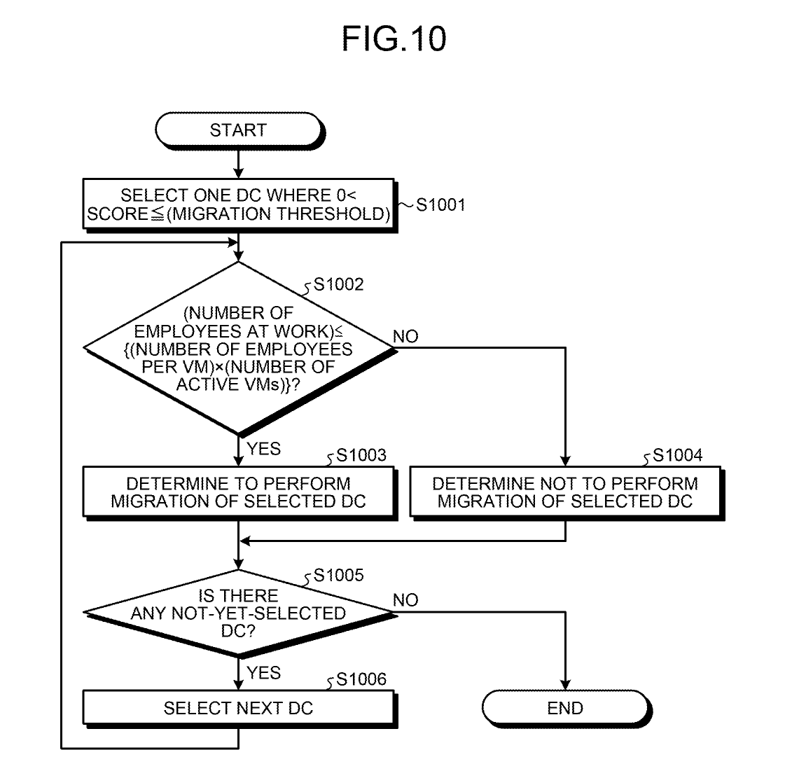

FIG. 10 is a flowchart illustrating an example of the procedure of an internal-risk-factor detecting process. The processing flow illustrated in FIG. 10 corresponds to Step S804 in FIG. 8.

First, the second determining unit 84 selects one data center of which the score is greater than zero but not greater than the migration threshold (Step S1001). Then, the second determining unit 84 determines whether the number of employees at work is equal to or less than a value obtained by multiplying the number of employees per VM by the number of active VMs with reference to the attendance/leaving information and data-center management information of the selected data center (Step S1002). If the second determining unit 84 has determined that the number of employees at work is equal to or less than {(the number of employees per VM)×(the number of active VMs)} (YES at Step S1002), the second determining unit 84 determines to perform migration of the data center (Step S1003). On the other hand, if the second determining unit 84 has determined that the number of employees at work is more than {(the number of employees per VM)×(the number of active VMs)} (NO at Step S1002), the second determining unit 84 determines not to perform migration of the data center (Step S1004). Then, the second determining unit 84 determines whether there is any not-yet-selected data center of which the score is greater than zero but not greater than the migration threshold (Step S1005). If the second determining unit 84 has determined that there is a not-yet-selected data center (YES at Step S1005), the second determining unit 84 selects the next data center (Step S1006), and returns to the process at Step S1002. On the other hand, if the second determining unit 84 has determined that there is no not-yet-selected data center (NO at Step S1005), the second determining unit 84 ends the process.

Example of Flow of First Migration Process

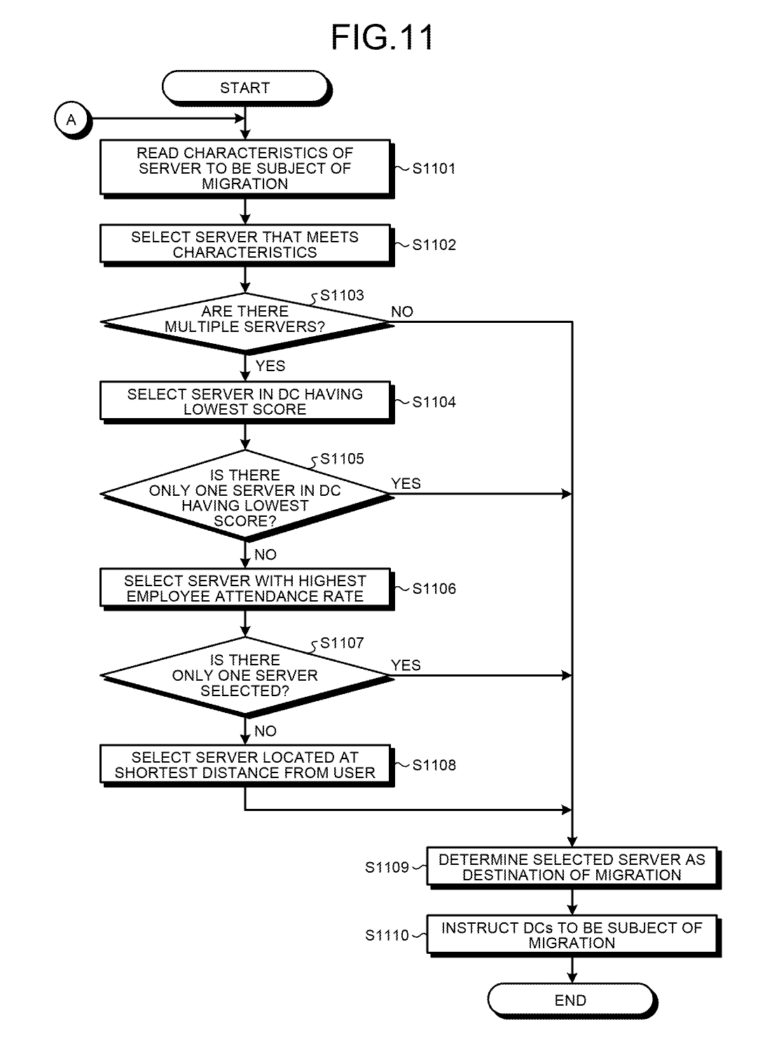

FIG. 11 is a flowchart illustrating an example of the procedure of the first migration process. The processing flow illustrated in FIG. 11 corresponds to Step S803 in FIG. 8.

First, the migration executing unit 85 reads characteristics of a server determined to have an external risk factor by the first determining unit 83, i.e., a resource to be subject of migration from the user management information storage area 74 (Step S1101). Then, the migration executing unit 85 selects a server that meets the read characteristics (Step S1102). And then, the migration executing unit 85 determines whether there are multiple servers selected at Step S1102 (Step S1103). If the migration executing unit 85 has determined that there are not multiple servers selected (NO at Step S1103), the migration executing unit 85 determines the server selected at Step S1102 as a destination of migration (Step S1109). On the other hand, if there are multiple servers selected (YES at Step S1103), the migration executing unit 85 moves on to Step S1104.

At Step S1104, the migration executing unit 85 selects a server placed in a data center having the lowest score of all the selected servers (Step S1104). Then, the migration executing unit 85 determines whether the number of servers placed in the data center having the lowest score is one (Step S1105). If the migration executing unit 85 has determined that the number of servers placed in the data center having the lowest score is one (YES at Step S1105), the migration executing unit 85 determines the one server selected at Step S1104 as a destination of migration (Step S1109). On the other hand, if the migration executing unit 85 has determined that the number of servers placed in the data center having the lowest score is not one (NO at Step S1105), the migration executing unit 85 moves on to Step S1106.

At Step S1106, the migration executing unit 85 selects a server with the highest employee attendance rate out of all the servers selected (Step S1106). The employee attendance rate here is the rate of a value obtained by dividing the actual attendance by the number of active VMs to the number of people set in advance as the number of employees needed to operate one VM in each data center. Then, the migration executing unit 85 whether the number of servers selected a server with the highest employee attendance rate is one (Step S1107). If the migration executing unit 85 has determined that the number of selected servers is one (YES at Step S1107), the migration executing unit 85 determines the one server selected as a destination of migration (Step S1109). On the other hand, if the migration executing unit 85 has determined that the number of selected servers is not one (NO at Step S1107), the migration executing unit 85 moves on to Step S1108.

At Step S1108, the migration executing unit 85 selects a server located at the shortest distance from a user of all the selected servers (Step S1108). Incidentally, when the distance from a user is used in the selection of a server, information on the distance between each database and a user can be stored in the user management information storage area 74 in advance. Then, the migration executing unit 85 determines the selected server as a destination of migration (Step S1109). Then, the migration executing unit 85 sends a request for the execution of migration to the migration source server and the server determined as a destination of migration (Step S1110). Then, the first migration process ends.

Example of Flow of Second Migration Process

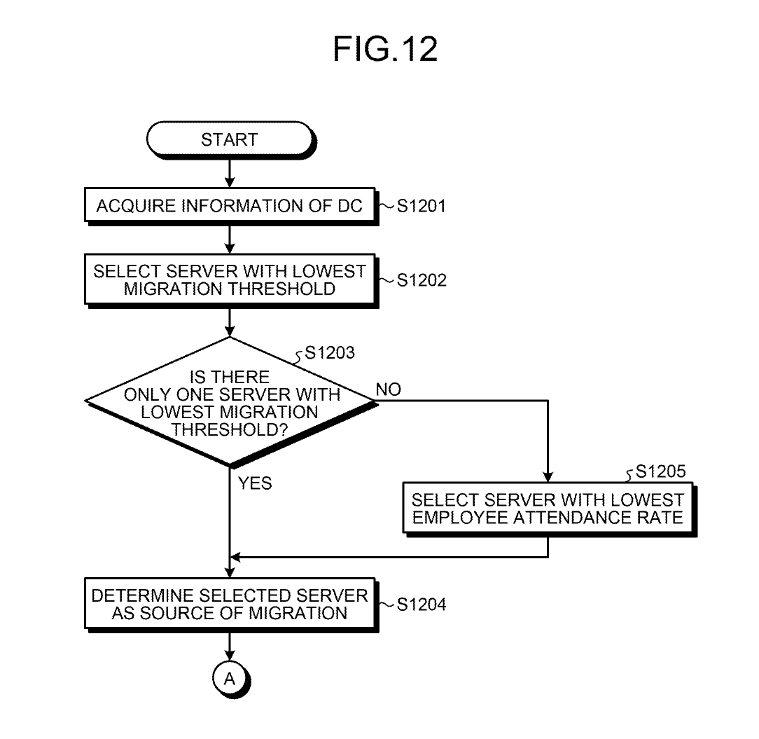

FIG. 12 is a flowchart illustrating an example of the procedure of the second migration process. The processing flow illustrated in FIG. 12 corresponds to Step S806 in FIG. 8.

First, the migration executing unit 85 acquires information of a data center determined to have an internal risk factor from the second determining unit 84 (Step S1201). Then, the migration executing unit 85 selects a server with the lowest migration threshold of all servers placed in the data center (Step S1202). And then, the migration executing unit 85 determines whether the number of servers selected is one (Step S1203). If the migration executing unit 85 has determined that the number of servers selected is one (YES at Step S1203), the migration executing unit 85 determines the selected server as a source of migration (Step S1204). On the other hand, if the migration executing unit 85 has determined that the number of servers selected is not one (NO at Step S1203), the migration executing unit 85 selects a server with the lowest employee attendance rate (Step S1205). Then, the migration executing unit 85 determines the selected server as a source of migration (Step S1204). Then, the migration executing unit 85 performs the same processes as Steps S1101 to S1110 in FIG. 11 and determines a destination of migration. Then, the second migration process ends.

Incidentally, the number of servers selected at Step S1108 in FIG. 11 or Step S1205 in FIG. 12 could possibly not be one; however, in such a case, servers shall be narrowed down to one by any method.

Furthermore, it may be possible that the employee attendance rate of every data center is lower than 1. Accordingly, a lower threshold limit of the employee attendance rate can be set in advance. Then, if the employee attendance rate of every data center is lower than the lower threshold limit, the information processing apparatus 11 can be configured to perform a process of sending an alert to the data centers.

Effects of First Embodiment

An information processing apparatus according to the first embodiment includes an acquiring unit, a calculating unit, a first determining unit, and a migration executing unit. The acquiring unit acquires information on the safety of respective locations where multiple data centers are placed through a network. The multiple data centers are able to communicate with one another. The calculating unit calculates respective scores indicating the safety of the multiple data centers on the basis of the information acquired by the acquiring unit. The first determining unit determines whether virtual machines built on each of the multiple data centers are to be moved or not on the basis of the scores. The migration executing unit moves virtual machines built on each of the multiple data centers from one data center to another on the basis of a result of the determination by the first determining unit. Therefore, the information processing apparatus according to the first embodiment can acquire information on the safety of respective locations where the data centers are placed from, for example, an information source outside of a data center and calculate a score indicating the safety with respect to each data center. Then, the information processing apparatus can determine a source of migration and a destination of migration in consideration of the location where each data center is placed and the safety of a country. Accordingly, it is possible to provide stably-high-quality services without any constraints of physical and geographical conditions of the data centers.

Furthermore, the information processing apparatus according to the first embodiment further includes a second determining unit that determines the respective operating status of the multiple data centers on the basis of respective employee attendance of the multiple data centers. Then, the migration executing unit moves virtual machines from one data center to another on the basis of a result of the determination by at least either one of the first and second determining units. Therefore, the information processing apparatus can determine whether to perform migration or not in consideration of the employee attendance state of each data center in addition to an external risk factor of a country where the data center is placed. Moreover, the information processing apparatus can appropriately select either or both of an internal risk factor and an external risk factor and perform migration on the basis of the factor(s).

Furthermore, the information processing apparatus according to the first embodiment further includes a storage unit. The storage unit stores therein the number of employees who work at each of the multiple data centers in a manner associated with the data center. The storage unit further stores therein the number of employees at work and the number of employees allocated for each virtual machine built on the data center. The storage unit still further stores therein the number of active virtual machines in the data center. Then, the second determining unit determines that the operating status of a data center where the number of employees at work is smaller than the number obtained by multiplying the number of employees per virtual machine by the number of active virtual machines is at risk. Furthermore, the second determining unit determines that the operating status of a data center where the number of employees at work is equal to or larger than the number obtained by multiplying the number of employees per virtual machine by the number of active virtual machines is not at risk. The migration executing unit performs migration with the data center determined to be at risk by the second determining unit as a source of migration. Therefore, the information processing apparatus can determine whether to perform migration or not according to whether human resources enough to operate virtual machines is secured in each data center.

Moreover, in the information processing apparatus according to the first embodiment, the storage unit further stores therein an event that affects the safety of the locations where each of the multiple data centers is placed. The storage unit further stores therein a first keyword corresponding to each event, a second keyword indicating the start of the event, and a third keyword indicating the end of the event. The calculating unit performs a first AND search with the first and second keywords and a second AND search with the first and third keywords on information acquired by the acquiring unit. The calculating unit calculates a score by adding a value according to the number of hits in the first AND search to a score and subtracting a value according to the number of hits in the second AND search from the score. If the score exceeds a predetermined threshold, the first determining unit determines movement of virtual machines built on the data center to another. The migration executing unit moves the virtual machines placed in the data center to another data center on the basis of a result of the determination by the first determining unit. Therefore, the information processing apparatus can detect the occurrence and end of an event that affects the safety of a location where a data center is placed on the basis of information acquired from the outside. Then, the information processing apparatus calculates a score that reflects the occurrence and end of an event that affects the safety, and performs migration on the basis of the score. Accordingly, the information processing apparatus can identify virtual machines to be subject of migration in the light of the safety of a location where the data center is placed.

Furthermore, in the information processing apparatus according to the first embodiment, if a score exceeds a predetermined threshold set for each pair of user and server, the first determining unit determines movement of virtual machines built on the data center. Therefore, the information processing apparatus can finely set the level of safety demanded. Accordingly, the information processing apparatus can provide cloud services meeting to users' minute demands on the safety.

Moreover, in the information processing apparatus according to the first embodiment, the calculating unit calculates respective scores using different factors set to the multiple data centers. Therefore, the information processing apparatus can calculate respective scores using different factors for the data centers placed in different areas or countries. Accordingly, the information processing apparatus can calculate a score that finely reflects the conditions of an area or country where each data center is placed. Consequently, the information processing apparatus can achieve the migration based on the score that accurately reflects the safety. Then, the information processing apparatus can assure the high level of safety and provide cloud services.

Furthermore, in the information processing apparatus according to the first embodiment, the calculating unit calculates respective scores using different weights for events. Therefore, the information processing apparatus can finely reflect differences in what events mean in the respective areas or countries where the data centers are placed and the impacts of the events on the safety. Accordingly, the information processing apparatus can perform a migration process in accurate reflection of the conditions of the areas or countries where the data centers are placed, and can assure the high level of safety and provide cloud services.

Moreover, in the information processing apparatus according to the first embodiment, the storage unit further stores therein a user who uses a resource of a data center, a resource allocated for the user, and a threshold indicating the safety level set to the resource in an associated manner. The migration executing unit selects a resource to be a source of migration from resources placed in a data center determined to be at risk by the second determining unit on the basis of the threshold. Therefore, with respect to each user, the safety level can be set and whether to perform migration or not can be determined, and therefore detailed services can be provided to users.

### [b] Second Embodiment

Example of Configuration of Information Processing System According to Second Embodiment

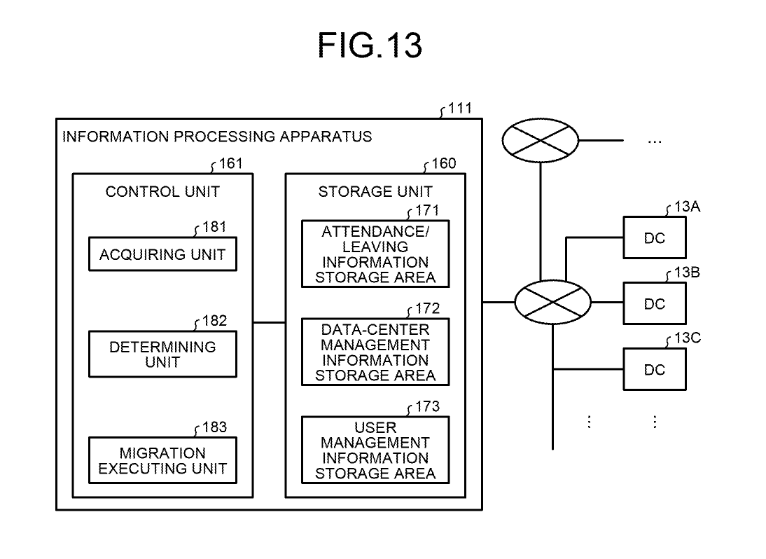

FIG. 13 is a diagram illustrating an example of a configuration of an information processing apparatus 111 according to a second embodiment. A configuration of an information processing system according to the second embodiment and a functional configuration of a data center according to the second embodiment are roughly the same as those in the first embodiment illustrated in FIGS. 1 and 2, so description of the same configurations and functions is omitted.

The information processing apparatus 11 according to the first embodiment shall determine whether to perform migration or not by detecting both internal and external risk factors and execute migration. However, an information processing apparatus according to the present invention is not limited to this, and can be configured to determine whether to perform migration or not by detecting either one of internal and external risk factors and execute migration. In the second embodiment, an information processing apparatus determines whether to perform migration or not by detecting an internal risk factor only and executes migration.

As illustrated in FIG. 13, the information processing apparatus 111 according to the second embodiment includes a storage unit 160 and a control unit 161. Incidentally, the information processing apparatus 111 can include various function units that a known computer has besides the function units illustrated in FIG. 13. For example, the information processing apparatus 111 can further include a display unit that displays thereon a variety of information and an input unit that inputs a variety of information.

The storage unit 160 is a storage device that stores therein various data. For example, the storage unit 160 is a storage device such as a hard disk, a solid state drive (SSD), or an optical disk. Incidentally, the storage unit 160 can be a data-rewritable semiconductor memory, such as a random access memory (RAM), a flash memory, or a non-volatile static random access memory (NVSRAM).

The storage unit 160 stores therein an operating system (OS) and various programs executed by the control unit 161. For example, the storage unit 160 stores therein various programs including programs that perform a determining process and a migration process to be described later. Furthermore, the storage unit 160 stores therein various data used in the programs executed by the control unit 161. For example, the storage unit 160 has an attendance/leaving information storage area 171, a data-center management information storage area 172, and a user management information storage area 173.

The attendance/leaving information storage area 171 stores therein information on the employees' attendance/leaving state in each data center 13. The attendance/leaving information in the second embodiment is the same in data components and contents as that in the first embodiment illustrated in FIG. 4.

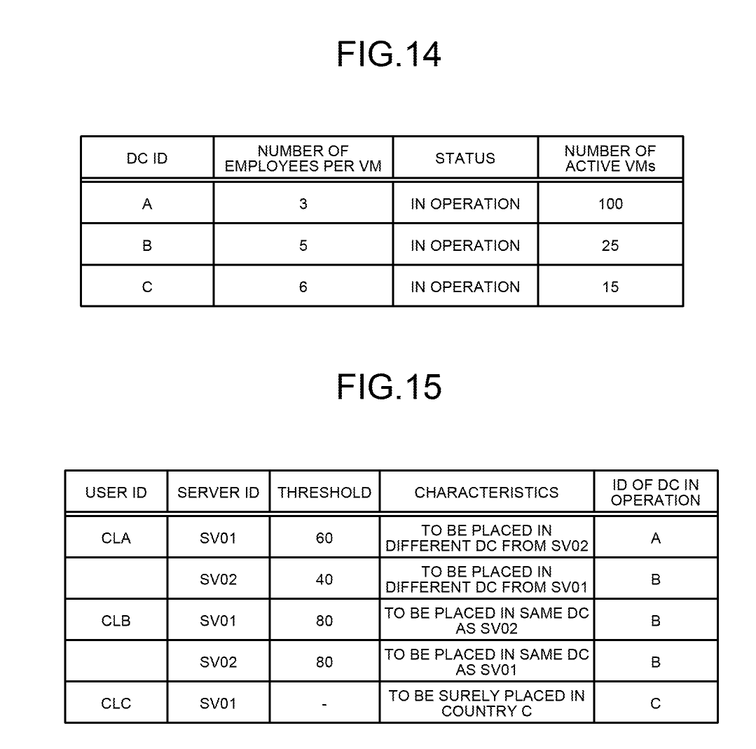

The data-center management information storage area 172 stores therein data-center management information that is information on virtual machines currently running on each data center 13 managed by the information processing apparatus 111. The data-center management information illustrated in FIG. 14 is the same as that in the first embodiment illustrated in FIG. 5. Furthermore, the information stored in the data-center management information storage area 172 in the second embodiment (FIG. 14) is about the same as that stored in the data-center management information storage area 72 in the first embodiment, except that the data-center management information storage area 172 does not include score.

The user management information storage area 173 stores therein user management information that is information on a user who has been receiving the provision of a resource of a data center 13 managed by the information processing apparatus 111 and the content of a service to the user. The user management information stored in the user management information storage area 173 is about the same as that stored in the user management information storage area 74 in the first embodiment, and differs from the first embodiment in that the user management information stored in the user management information storage area 173 includes “threshold” and not migration threshold. The “threshold” indicates a standard for the safety to be guaranteed in the provision of a resource to a user. The example illustrated in FIG. 15 indicates that the higher the “threshold”, the lower level of safety is demanded; on the contrary, the lower the “threshold”, the higher level of safety is demanded.

To return to FIG. 13, the control unit 161 is a device that controls the information processing apparatus 111. As the control unit 161, electronic circuits, such as a central processing unit (CPU) and a micro processing unit (MPU), or integrated circuits, such as an application specific integrated circuit (ASIC) and a field programmable gate array (FPGA), can be adopted. The control unit 161 has an internal memory for storing therein various programs and control data that define processing procedures, and executes various processes with these. The control unit 161 serves as various processing units by the activation of the programs. For example, the control unit 161 includes an acquiring unit 181, a determining unit 182, and a migration executing unit 183.

The acquiring unit 181 acquires various data. For example, the acquiring unit 181 acquires information on the employees' attendance/leaving state from each data center 13, and stores the acquired information in the attendance/leaving information storage area 171 and updates the attendance/leaving information storage area 171 of the storage unit 160.

The determining unit 182 determines whether there is any internal risk factor that is a factor in the occurrence of an internal risk on the basis of the information stored in the storage unit 160. For example, the determining unit 182 determines whether there is any internal risk factor on the basis of the employees' attendance/leaving state in each data center 13. For example, when a data center is placed in a country with low level of technology, even if there arises a problem that the number of employees at work is not enough to meet the number of employees per VM set in advance, there is a possibility of failing to deal with the problem quickly. Accordingly, the information processing apparatus 111 determines the presence or absence of an internal risk factor on the basis of the employees' attendance/leaving state in each data center 13.

For example, the determining unit 182 determines whether virtual machines more than those covered by the employees at work who can handle are running on the basis of attendance/leaving information and data-center management information. For example, the determining unit 182 determines whether the number obtained by dividing the “employee attendance” stored in the attendance/leaving information storage area 171 by the “number of employees per VM” stored in the data-center management information storage area 172 is equal to or more than the “number of active VMs”. If (the employee attendance)/(the number of employees per VM) is equal to or more than the number of active VMs, the determining unit 182 determines that there is no internal risk factor. On the other hand, if (the employee attendance)/(the number of employees per VM) is less than the number of active VMs, the determining unit 182 determines that there is an internal risk factor.

The migration executing unit 183 performs a migration process on the basis of a result of the determination by the determining unit 182. For example, if the determining unit 182 has determined that a data center 13A has an internal risk factor, the migration executing unit 183 selects a resource to be subject of migration from resources in the data center 13A. Furthermore, the migration executing unit 183 selects a data center to be a destination of migration from the other data centers 13B and 13C. Then, the migration executing unit 183 moves the selected resource to the selected migration-destination data center.

For example, the migration executing unit 183 selects, as the subject of migration, a resource with the highest level of safety demanded out of resources placed in the data center 13A. The resource with the highest level of safety demanded here is a resource with the lowest “threshold” in those stored in the user management information storage area 173. For example, with reference to the user management information storage area 173, the migration executing unit 183 selects a resource with the lowest threshold among resources placed in the data center 13A (“ID of DC in operation: A”). In the example illustrated FIG. 15, as there is only one server meeting “ID of DC in operation: A”, the migration executing unit 183 selects the server identified by user ID “CLA” and server ID “SV01” as the subject of migration.

Then, with reference to “characteristics” stored to be associated with user ID “CLA” and server ID “SV01”, the migration executing unit 183 selects a data center other than the one where SVO2 is placed, i.e., a data center with DC ID “C”.

Furthermore, the migration executing unit 183 calculates an employee rate of the data center with DC ID “C”. The employee rate here is a rate of the number of obtained by dividing the “employee attendance” stored in the attendance/leaving information storage area 171 by the “number of active VMs” stored in the data-center management information storage area 172 to the “number of employees per VM”. That is, the employee rate is an index representing the level at which employees at work can handle the operations of active VMs. The higher the employee rate, the lower the internal risk; the lower the employee rate, the higher the internal risk. With reference to FIGS. 4 and 14, the employee rate of the data center with DC ID “C” is (100/15)/6 (>1). That means the internal risk of the data center with DC ID “C” is low. If there are multiple candidates for a destination of migration, the migration executing unit 183 calculates respective employee rates of the migration destination candidates in the same way, and selects a data center with the highest employee rate.

Flow of Migration Control Process

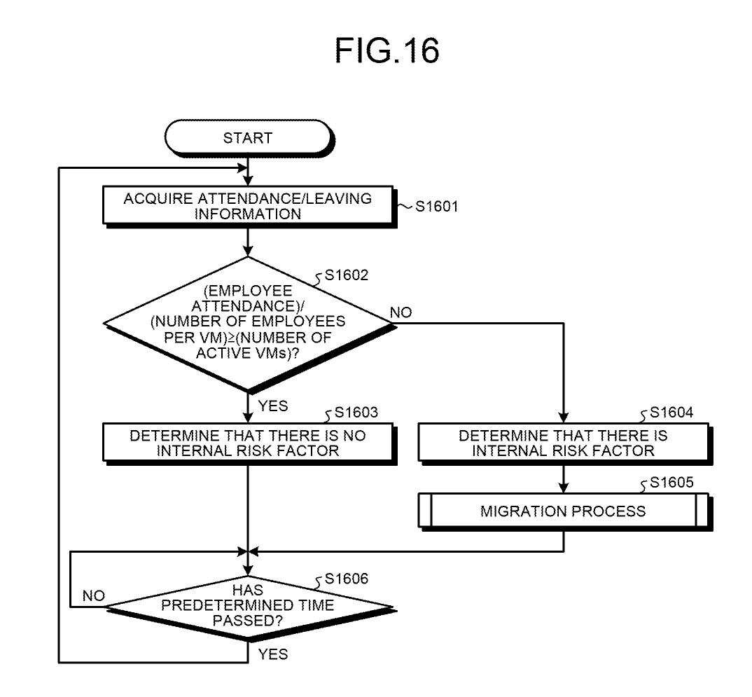

FIG. 16 is a flowchart illustrating an example of the procedure of a migration control process according to the second embodiment. When the migration control process has started in information processing apparatus 111 according to the second embodiment, first, the acquiring unit 181 acquires attendance/leaving information of employees of each data center 13 (Step S1601). The attendance/leaving information acquired by the acquiring unit 181 is stored in the storage unit 160, and the storage unit 160 is updated with the attendance/leaving information acquired by the acquiring unit 181. Then, with reference to the attendance/leaving information storage area 171 and the data-center management information storage area 172, the determining unit 182 determines whether there is any internal risk factor in each data center. For example, the determining unit 182 determines whether virtual machines more than those covered by employees at work in each data center by determining whether (the employee attendance)/(the number of employees per VM) is equal to or more than the number of active VMs (Step S1602).

If the determining unit 182 has determined that (the employee attendance)/(the number of employees per VM) is equal to or more than the number of active VMs (YES at Step S1602), the determining unit 182 determines that there is no internal risk factor (Step S1603). On the other hand, if the determining unit 182 has determined that (the employee attendance)/(the number of employees per VM) is less than the number of active VMs (NO at Step S1602), the determining unit 182 determines that there is an internal risk factor (Step S1604). Then, the determining unit 182 passes a result of the determination to the migration executing unit 183, and the migration executing unit 183 performs a migration process (Step S1605). After Steps S1603 and S1605, the acquiring unit 181 determines whether a predetermined time has passed since the last acquisition of attendance/leaving information (Step S1606). Then, if the acquiring unit 181 has determined that the predetermined time has not passed (NO at Step S1606), the acquiring unit 181 repeats the determination at Step S1606. On the other hand, if the acquiring unit 181 has determined that the predetermined time has passed (YES at Step S1606), the acquiring unit 181 returns to Step S1601, and the migration control process is again performed.

Example of Flow of Migration Process

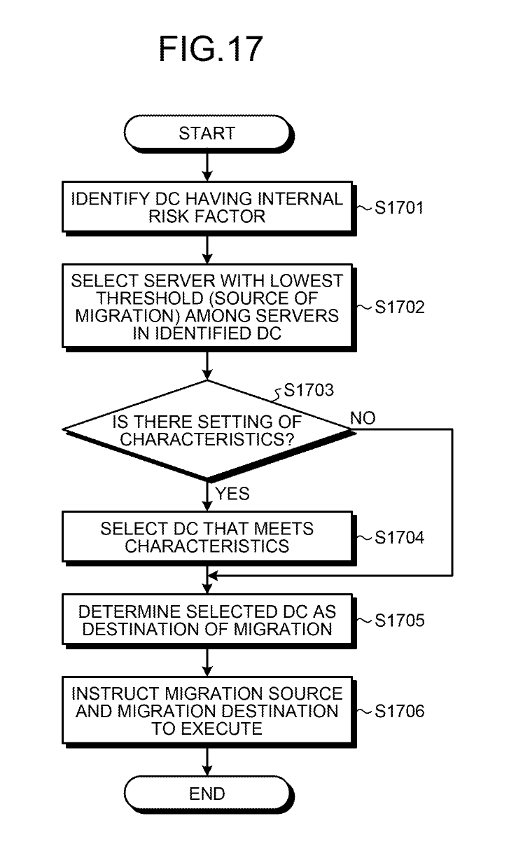

FIG. 17 is a flowchart illustrating an example of the procedure of a migration process according to the second embodiment. The processing flow illustrated in FIG. 17 is performed by the migration executing unit 183 at Step S1605 in FIG. 16.

The migration process is performed if the determining unit 182 has determined that there is an internal risk factor (at Step S1604 in FIG. 16). First, the migration executing unit 183 identifies a date center determined to have an internal risk factor (Step S1701). Then, with reference to the user management information storage area 173, the migration executing unit 183 selects a server with the lowest threshold among servers placed in the identified data center as a source of migration (Step S1702). Furthermore, the migration executing unit 183 determines whether characteristics are set to the selected server (Step S1703). If the migration executing unit 183 has determined that characteristics are set (YES at Step S1703), the migration executing unit 183 selects a data center that meets the characteristics (Step S1704). On the other hand, if the migration executing unit 183 has determined that characteristics are not set (NO at Step S1703), the migration executing unit 183 moves on to Step S1705. At Step S1705, the migration executing unit 183 determines the data center selected at Step S1702 or S1704 as a destination of migration (Step S1705). Then, the migration executing unit 183 migrates the selected migration source to the determined migration destination (Step S1706). Then, the migration process is completed.

Effects of Second Embodiment

In this way, an information processing apparatus according to the second embodiment includes a second determining unit that determines the respective operating status of multiple data centers on the basis of the employee attendance of each of the data centers. The migration executing unit moves virtual machines placed in each of the multiple data centers from one data center to another on the basis of a result of the determination by the second determining unit. Therefore, the information processing apparatus according to the second embodiment can determine the presence or absence of an internal risk factor of a data center on the basis of the employee attendance. Then, the information processing apparatus according to the second embodiment can quickly move resources of a data center having an internal risk factor to another data center. Therefore, the information processing apparatus according to the second embodiment can provide stably-high-quality services without any constraints of physical and geographical conditions of the data centers.

Example of Configuration of Embodiments

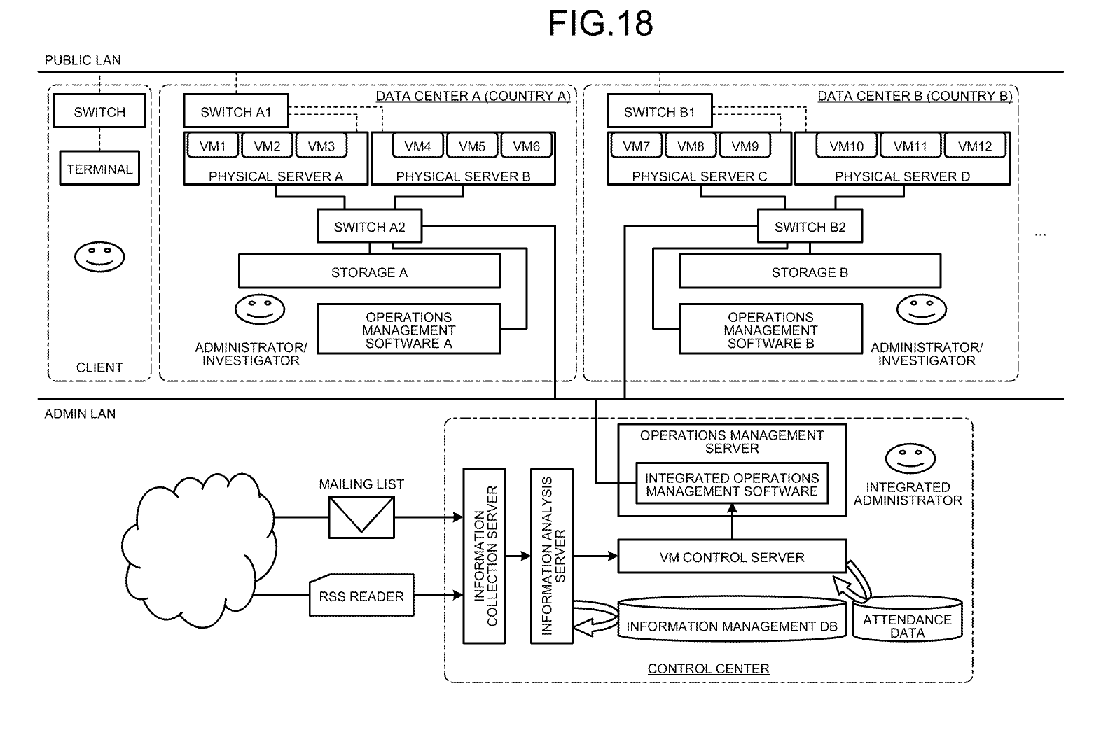

FIG. 18 is a diagram illustrating an example of a system configuration that realizes an information processing system according to any of the embodiments. An information processing system according to any of the first and second embodiments can be realized by using the configuration illustrated in FIG. 18. In the example illustrated in FIG. 18, a data center A placed in Country A and a data center B placed in Country B are connected to each other via a public local area network (LAN). The data center A and the data center B are connected to a client terminal via the public LAN and a switch. The data center A and the data center B have about the same configuration and functions, so in the following description, a reference numeral of a component of the data center A comes with a reference numeral of a corresponding component of the data center B in a parenthesis.

Multiple physical servers A, B (C, D) are placed in the data center A (B), and are connected to the public LAN via a switch A1 (B1). Virtual machines VM1 to VM3, VM4 to VM6 (VM7 to VM9, VM10 to VM12) are built on the physical servers A, B (C, D), respectively. The physical servers A, B (C, D) are connected to an admin LAN via a switch A2 (B2). Furthermore, the physical servers A, B (C, D) are connected to storage A (B) and operations management software A (B) via the switch A2 (B2). The physical servers A, B (C, D) use information stored in the storage A (B), and their operations are managed by the function of the operations management software A (B). Furthermore, an administrator/investigator is allocated to each data center.

The data centers A, B are connected to a control center corresponding to the information processing apparatus according to any of the embodiments via the admin LAN. Integrated operations management software that integrates the functions of the data centers in cooperation with the operations management software installed in the data centers is installed in the control center. The control center includes an information collection server, an information analysis server, a VM control server, an operations management server, and an information management database (DB). Furthermore, an integrated administrator is allocated to the control center.

The information collection server is a server that collects information on the safety of Country A and Country B where the data centers A, B are placed. The information collection server collects information from a network through a mailing list and an RSS reader. The information collected by the information collection server is sent to the information analysis server. The information analysis server analyzes the information collected by the information collection server, and stores extracted information in the information management DB. Furthermore, the information analysis server determines whether any internal risk factor or any external risk factor occurred in either data center. A result of the determination is sent to the VM control server. When having received the result of the determination from the information analysis server, the VM control server performs a migration process. The VM control server sends an instruction related to migration to the operations management server. The integrated operations management software running on the operations management server receives the instruction related to migration, and sends the instruction to the data centers A, B. Then, the migration process is performed in the data centers A, B. The VM control server uses attendance data acquired from the data centers A, B, respectively, in the determination on migration.

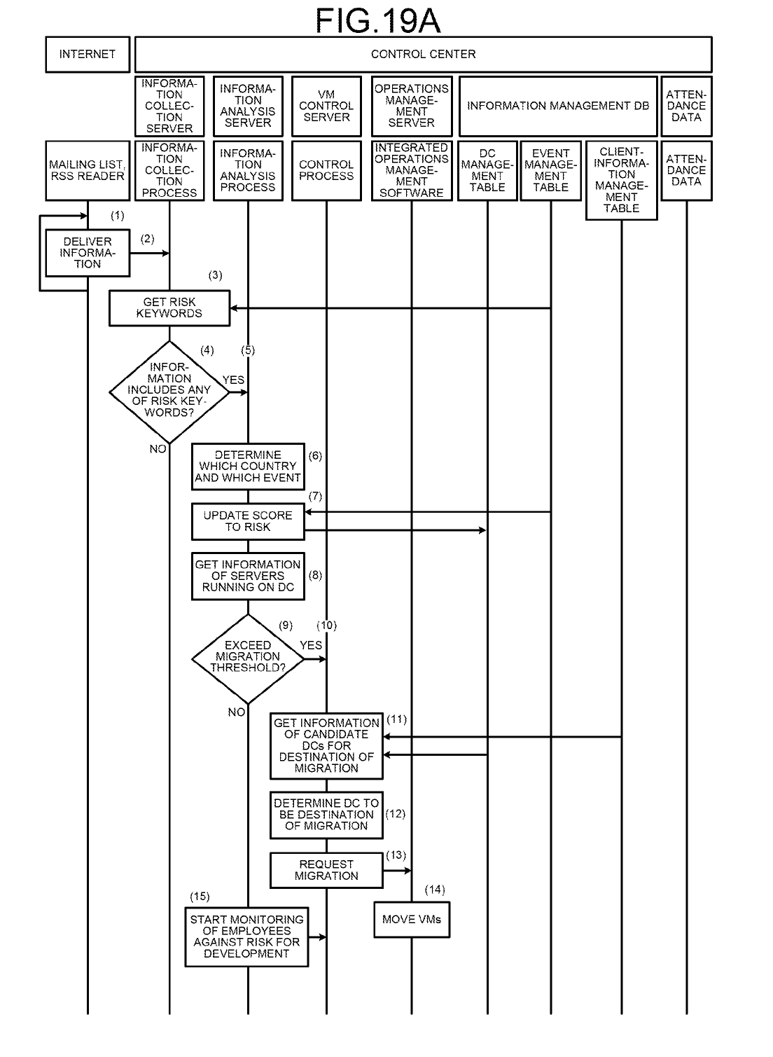

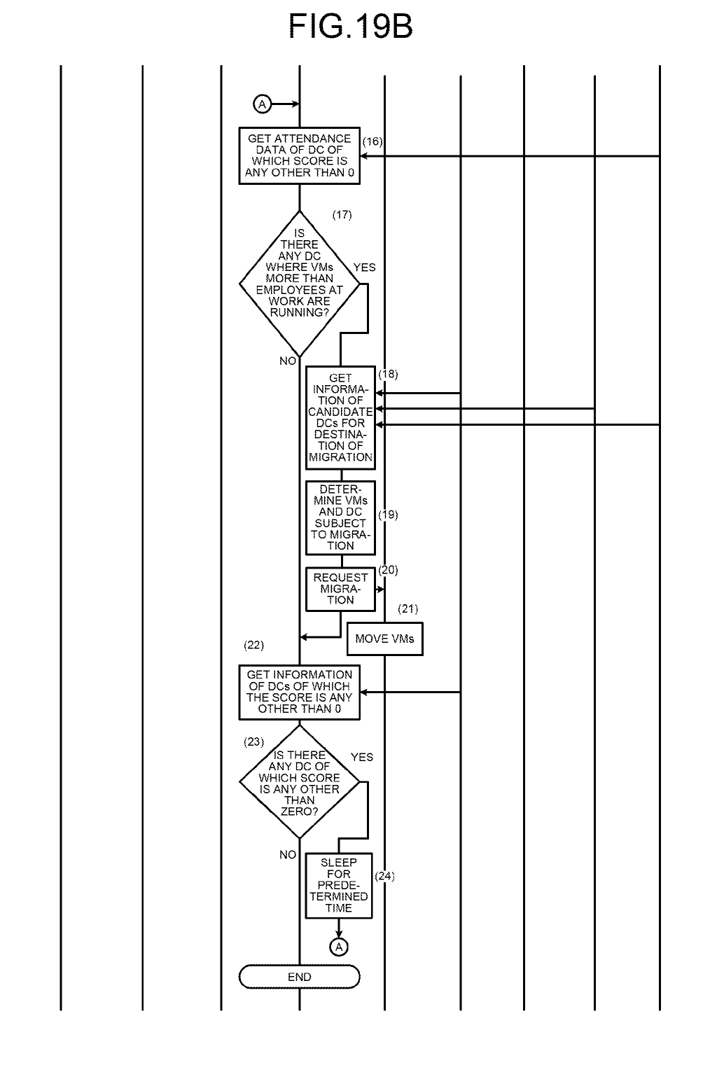

The information collection server, the information analysis server, and the VM control server in FIG. 18 mostly correspond to the acquiring unit 81, the calculating unit 82 and the first and second determining units 83 and 84, and the migration executing unit 85 illustrated in FIG. 3, respectively. The information management DB mostly corresponds to the storage unit 60 in FIG. 3. A data-center management table, an event management table, and a client-information management table (see FIG. 19A) that the information management DB includes correspond to the data-center management information, the event management information, and the user management information, respectively. The attendance data corresponds to the attendance/leaving information in FIG. 4.

An example of how to realize a migration control process according to any of the embodiments in the configuration illustrated in FIG. 18 is explained with reference to FIGS. 19A and 19B. FIGS. 19A and 19B are sequence charts illustrating an example of the procedure of the migration control process in the information processing system according to any of the embodiments.

First, information is delivered via the Internet ((1) in FIG. 19A). The delivered information is acquired by the information collection server through a mailing list and the RSS reader ((2) in FIG. 19A). The information collection server gets risk keywords with reference to the event management table ((3) in FIG. 19A). Then, the information collection server determines whether the information acquired at (2) includes any of the risk keywords ((4) in FIG. 19A). If any of the risk keywords are included (YES at (4) in FIG. 19A), the information collection server passes the process to the information analysis server ((5) in FIG. 19A). If none of the risk keywords are included (NO at (4) in FIG. 19A), the information collection server ends the process.

The information analysis server determines which country and which event a risk keyword included in the information corresponds to on the basis of the information received from the information collection server ((6) in FIG. 19A). Then, the information analysis server calculates a score with reference to the event management table, and updates the DC management table with the calculated score ((7) in FIG. 19A). A method for the score calculation and update is the same as described in the second embodiment. Then, the information analysis server acquires information of servers running on data centers ((8) in FIG. 19A). Furthermore, the information analysis server determines whether there is any server of which the data center's score exceeds a migration threshold on the basis of the acquired information of servers ((9) in FIG. 19A). If the information analysis server has determined that there is a server of which the data center's score exceeds the migration threshold (YES at (9) in FIG. 19A), the information analysis server passes the process to the VM control server ((10) in FIG. 19A).

The VM control server receives information of the server of which the data center's score exceeds the migration threshold, and starts a process for selecting a migration destination of the server. With reference to the DC management table and the client-information management table, the VM control server first acquires information of data centers that are candidates for a destination of migration ((11) in FIG. 19A). Then, the VM control server determines a data center to be a destination of migration on the basis of predetermined selection criteria ((12) in FIG. 19A). The selection criteria are, for example, the selection method described in the second embodiment. Then, the VM control server sends a migration request to the operations management server ((13) in FIG. 19A). When having received the migration request, the operations management server performs migration of virtual machines by using the function of the integrated operations management software ((14) in FIG. 19A). A method for the migration is not specifically limited.

The above processes mostly correspond to the external-risk-factor detecting process and the first migration process in the first embodiment.

In the example illustrated in FIGS. 19A and 19B, the control center continues to perform monitoring of the data center of which the score has been determined to be equal to or less than the migration threshold at (9) (NO at (9) in FIG. 19A) based on the employee attendance data ((15) in FIG. 19A). When the monitoring has started, first, the VM control server extracts data centers of which the score is any other than zero among data centers of which the score is equal to or less than the migration threshold. Then, the VM control server acquires attendance data of the extracted data centers ((16) in FIG. 19B). The VM control server identifies a data center where the number of employees at work has not reached the number of employees needed to operate active VMs on the basis of the acquired attendance data ((17) in FIG. 19B). That is, the VM control server identifies a data center where VMs more than those covered by the employees at work are running by the employee attendance. A data center to be a source of migration is identified in this way. When a data center has been identified (YES at (17) in FIG. 19B), the VM control server acquires information of data centers that are candidates for a destination of migration with reference to the DC management table, the client-information management table, and the attendance data ((18) in FIG. 19B). Then, the VM control server selects a server to be a source of migration and a data center to be a destination of migration on the basis of predetermined conditions ((19) in FIG. 19B). The predetermined conditions are, for example, the conditions described in the second embodiment. When having determined the subjects of migration, the VM control server requests the operations management server to perform migration ((20) in FIG. 19B). Upon receipt of the request, the operations management server performs migration ((21) in FIG. 19B).

At (17) in FIG. 19B, if a data center to be subject of migration has not been identified (NO at YES at (17) in FIG. 19B) and after the request for migration at (20), the VM control server further acquires score information of data centers ((22) in FIG. 19B). At this time, the VM control server refers to the DC management table. Then, the VM control server determines whether there is any data center of which the score is any other than zero ((23) in FIG. 19B). If it has been determined that there is a data center of which the score is any other than zero (YES at (23) in FIG. 19B), which means there still exists a resource at risk; therefore, the VM control server waits for a predetermined length of time ((24) in FIG. 19B), and after that, the VM control server again performs the processes at (16) onwards. If there are only data centers of which the score is zero left (NO at (23) in FIG. 19B), which means there is no resource at risk; therefore, the VM control server ends the process.

### [c] Third Embodiment

There are described above the embodiments relating to apparatus; however, the technology discussed herein can be embodied in various different forms besides the above embodiments. Other embodiments included in the present invention will be described below.

For example, in the examples illustrated in FIGS. 18 and 19, the detection of an internal risk factor based on employees' attendance/leaving information is performed if it has been determined that there is no external risk factor and when migration has not yet been performed. However, the technology discussed herein is not limited to this; for example, it can be configured to perform the monitoring of employees' attendance/leaving information and then determine an external risk factor only if no internal risk factor has been detected.

Furthermore, components of each apparatus illustrated in the drawings are functionally conceptual ones, and do not necessarily have to be physically configured as illustrated in the drawings. That is, the specific forms of division and integration of components of each apparatus are not limited to those illustrated in the drawings; all or some of the components can be configured to be functionally or physically divided or integrated in arbitrary units according to various loads and usage conditions, etc. For example, processing units of the acquiring unit 81, the calculating unit 82, the first determining unit 83, the second determining unit 84, and the migration executing unit 85 can be integrated appropriately. A processes performed by each processing unit can be appropriately divided into pieces to be performed by multiple processing units. Moreover, all or any part of processing functions implemented in the processing units can be realized by a CPU and a program analyzed and executed by the CPU, or can be realized as hardware by wired logic.

Migration Control Program

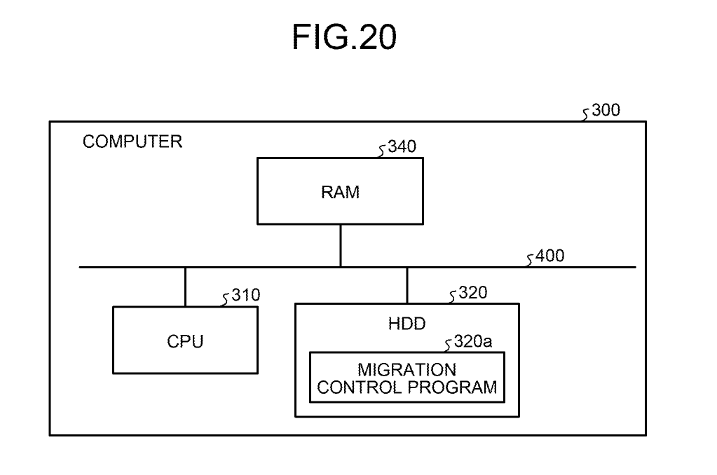

Furthermore, the various processes described in the above embodiments can be also realized by causing a computer system, such as a personal computer or a workstation, to execute a program prepared in advance. An example of the computer system that executes a program having the same functions as those described in the above embodiments is explained below. FIG. 20 is a diagram illustrating a computer that executes a migration control program.

As illustrated in FIG. 20, a computer 300 includes a central processing unit (CPU) 310, a hard disk drive (HDD) 320, and a random access memory (RAM) 340. These units 310 to 340 are connected by a bus 400.

A migration control program 320a is stored in the HDD 320 in advance; the migration control program 320a fulfills the same functions as the acquiring unit 81, the calculating unit 82, the first determining unit 83, the second determining unit 84, and the migration executing unit 85. Incidentally, the migration control program 320a can be divided appropriately.

The HDD 320 also stores therein a variety of information. For example, the HDD 320 stores therein an OS and various data used in production planning.

The CPU 310 reads out the migration control program 320a from the HDD 320 and executes the read program, thereby performing the same operations as the processing units in the embodiments. That is, the migration control program 320a performs the same operations as the acquiring unit 81, the calculating unit 82, the first determining unit 83, the second determining unit 84, and the migration executing unit 85.

Incidentally, the migration control program 320a does not necessarily have to be stored in the HDD 320 from the beginning.

For example, the migration control program 320a can be stored in a “portable physical medium”, such as a flexible disk (FD), a CD-ROM, a CD-R, a DVD, a magneto-optical disk, or an IC card, to be inserted into the computer 300. Then, the computer 300 can read the program from the portable physical medium and execute the read program.

Furthermore, the migration control program 320a can be stored on “another computer (or a server)” connected to the computer 300 via a public circuit, the Internet, a LAN, a WAN, or the like. Then, the computer 300 can read the program from this and execute the read program.

According to an aspect of the present invention, it is possible to provide services with stable quality.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and executes a process comprising:
acquiring information on safety of locations where multiple data centers are placed through a network, the multiple data centers being able to communicate with one another;
calculating scores respectively indicating the safety of the multiple data centers on the basis of the acquired information;
firstly determining whether to move virtual machines built on each of the multiple data centers on the basis of the scores; and
moving virtual machines placed in one data center to another data center on the basis of a result of the determination in the firstly determining.

2. The information processing apparatus according to claim 1, wherein the process further comprises
secondly determining an operating status of each of the multiple data centers on the basis of employee attendance of the multiple data centers, wherein
the moving moves virtual machines placed in one data center to another data center on the basis of a result of the determination in at least one of the firstly determining and secondly determining.

3. The information processing apparatus according to claim 2, wherein the memory stores therein a number of employees who work at each of the multiple data centers, a number of employees at work, a number of employees allocated for each virtual machine built on the data center, and a number of active virtual machines in the data center in a manner associated with the multiple data centers, wherein
the secondly determining determines that the operating status of a data center where the number of employees at work is equal to or smaller than the number obtained by multiplying the number of employees per virtual machine by the number of active virtual machines is at risk, and determines that the operating status of a data center where the number of employees at work is larger than the number obtained by multiplying the number of employees per virtual machine by the number of active virtual machines is not at risk, and
the moving performs migration with the data center determined to be at risk in the secondly determining as a source of migration.

4. The information processing apparatus according to claim 3, wherein
the memory further stores therein a user who uses a resource of a data center, a resource allocated for the user, and a threshold indicating the safety level set to the resource in an associated manner, and
the moving selects a resource to be a source of migration from resources placed in a data center determined to be at risk by the secondly determining on the basis of the threshold.

5. The information processing apparatus according to claim 1, wherein
the memory further stores therein an event that affects the safety of the locations where each of the multiple data centers is placed, a first keyword corresponding to the event, a second keyword indicating the start of the event, and a third keyword indicating the end of the event,
the calculating performs a first AND search with the first and second keywords and a second AND search with the first and third keywords on the information acquired in the acquiring, and calculates a score by adding a value according to the number of hits in the first AND search to the score and subtracting a value according to the number of hits in the second AND search from the score,
when the score exceeds a predetermined threshold, the firstly determining determines to move virtual machines built on the data center to another data center, and
the moving moves the virtual machines placed in the data center to another data center on the basis of a result of the determination in the firstly determining.

6. The information processing apparatus according to claim 5, wherein
the calculating calculates the scores using different weights for events.

7. The information processing apparatus according to claim 1, wherein
when a score exceeds a predetermined threshold set for each pair of user and server, the firstly determining determines to move virtual machines built on the data center.

8. The information processing apparatus according to claim 1, wherein
the calculating calculates the scores using different factors set to the multiple data centers.

9. A non-transitory computer-readable recording medium having stored therein a migration control program that causes a computer to execute a process comprising:
acquiring information on safety of locations where multiple data centers are placed through a network, the multiple data centers being able to communicate with one another;
calculating scores respectively indicating the safety of the multiple data centers on the basis of the acquired information;
determining whether to move virtual machines built on each of the multiple data centers on the basis of the calculated scores; and
moving virtual machines placed in one data center to another data center on the basis of a result of the determination.

10. An information processing system comprising:
multiple data centers that are placed in different locations, respectively, and are able to communicate with one another; and
an information processing apparatus that includes:
a memory; and
a processor coupled to the memory and executes a process comprising:
acquiring information on safety of the locations where the multiple data centers are placed, respectively, through a network;
calculating scores respectively indicating the safety of the multiple data centers on the basis of the acquired information;
a firstly determining whether to move virtual machines built on each of the multiple data centers on the basis of the scores; and
moving virtual machines placed in one data center to another data center on the basis of a result of the determination in the firstly determining.
